(19) United States
(12) Patent Application Publication
(10) Pub. No.: US 2004/0087402 A1
(43) Pub. Date: May 6, 2004

(54) Power transmission system

(76) Inventor: Harold Armstead Hunter JR., Winston-Salem, NC (US)

Correspondence Address: Harold Armstead Hunter, Jr., 5209 Pembrooke Forest Ct., Winston-Salem, NC, 27106, US

(21) Appl. No.: 10/283,925

(22) Filed: Oct. 31, 2002

(51) Int. Cl. F16H 55/12; F16H 55/30

(52) U.S. Cl. 474/160

(57) ABSTRACT

A power transmission system used in connection with a vehicle power wheel of a bicycle or other vehicle which has a fixed axle and which utilizes a rotating chain sprocket engaging an endless chain for receiving an input torque and transmitting an output torque. The system includes a transmission cadence varying apparatus that is operably connected to the wheel by an endless chain. The transmission cadence apparatus incorporates a left crank arm fixedly secured to a spindle which is fixedly secured to a left drive plate which incorporates a radial slot for a cam post to travel. A post ring is eccentrically mounted relative to the spindle via ball bearing means on the post ring housing which is then fixedly secured to the bicycle bottom bracket frame. The post ring incorporates 2 cam posts that are rigidly mounted 180 degrees apart in which one of the cam post drives the left drive plate radial slot and the other cam post drives the right crank radial slot. A right crank arm is rotatably secured via ball bearing means to the spindle. A geneva plate incorporates 3 radial slots for the cam post to travel and is rotatably mounted about the spindle via ball bearing means between the left drive plate and the right crank. The geneva plate also incorporate the sprocket in which to transmit the power via the endless chain to the rear wheel.

### FIELD OF THE INVENTION

The present invention relates to a power transmission system and, more particularly, to a system including bicycle cranks wherein cam posts are rotated eccentrically by opposing crank arms to achieve varying crank arm speeds with constant input speed and constant output speed.

### DESCRIPTION OF THE PRIOR ART

A variety of variable crank mechanisms are known such as that shown in U.S. Pat. No. 6,253,639 (Richardson). This devise varies the forces to the crank via the extending and retracting the pedal carrier arm. Another type of system shown in U.S. Pat. No. 5,419,572 (Stiller) which converts linear and elliptical motion to rotary motion. For both of these devises, there are variables in this type of construction that make it difficult to precisely drive the transmission efficiently and to avoid excessive wear. A system shown in U.S. Pat. No. 5,067,370 (Lemmens) covers a variable crank pedal drive system utilizing oppositely-directing crank arms, an eccentrically supported eccentric collar and an output torque wheel. While this patented devise reflects a relatively new approach to variable crank transmission systems, there is a limitation with respect to the output torque wheel rotation about the second axis in such a way that the chain ring angular velocity is not always constant with respect to the applied crank arm. Thus, there is a need to provide an even more efficient and more specific variation in the torque transmission of such transmission system. It is to this that the present application is directed.

### SUMMARY AND OBJECTIVES OF THE INVENTION

The present invention is a new and improved power transmission system for bicycles and other vehicles utilizing a standard fixed axle and rotating chain sprocket engaging an endless chain that receives an input torque and transmits an output torque. The system includes a transmission cadence varying apparatus having opposing crank arms engaged with cam posts which are rigidly secured to a post ring which is eccentrically located relative to the crank arms. A geneva plate is between the crank arms and engaged with the cam posts and rotates on the same axis as that of the crank arms. A sprocket is fixedly secured to the geneva plate which transmits the power via an endless chain to the rear wheel of the vehicle. Rotation of a crank arm causes the opposing crank arm to rotate at a different speed and yet the geneva plate always rotates the same as that of the slower crank arm. Due to the eccentric location of the post ring/cam post relative to the spindle, there is only one of the cam post engaged with the one of the radial slots of the geneva plate at any given time (the 120 degrees apex of the post ring arc relative to the spindle). Therefore, at a specified mounting angle relative to the bicycle frame chainstay so that the rider utilizes the optimum tangential force to the crank pedals from the riders position on the bicycle, the left crank is rotated 120 degrees which in turn drives the geneva plate 120 degrees and the right crank 240 degrees. Conversely, when the right crank is the proper angle for rider force input, the right crank is rotated 120 degrees which in turn drives the post ring that drives the geneva plate 120 degrees and the left crank 240 degrees.

From the summary set forth above, it can be seen that a primary objective of the present invention is to provide a new and improved power transmission system for bicycles and other vehicles which has all of the advantages of prior art assemblies and none of the disadvantages.

It is another objective of the present invention to provide a new and improved power transmission system of the type described which utilizes crank arms that experience a changing relationship with each other to be driven via cam posts eccentrically located on a post ring thereby varying the cadence of the crank arms relative to the sprocket.

Yet still another objective of the present invention is to provide a new and improved power transmission system of the type described which is capable of being retrofitted to existing bottom bracket frames of the majority of standard bicycles.

Thus, there has been outlined the more important features of the invention in order that the detailed description that follows may be better understood and in order that the present contribution to the art may be better appreciated. There are, of course, additional features of the invention that will be described hereinafter and which will form the subject matter of the claims appended hereto. In this respect, it is to be understood that the invention is not limited in its application to the details of construction and to the arrangement of the components set forth in the following description or illustrated in the drawings. The invention is capable of other embodiments and of being practiced and carried out in various ways.

It is also to be understood that the phraseology and terminology employed herein are for the purposes of description and should not be regarded as limiting. Those skilled in the art will appreciate that the concept upon which this disclosure is based may be readily utilized as a basis for the designing of other structures, methods and systems for carrying out the several purposes of the present invention.

Thus, the enumerated objectives and others identified hereinafter, along with the various features of novelty which characterize the invention, are pointed out with particularity in the claims annexed hereto and forming a part of this disclosure. For a better understanding of the invention, its operating advantages and the specific objectives attained by its use, reference is made to the accompanying drawings forming a part of the specifications in which like characters of reference designate like parts throughout the several views.

### BRIEF DESCRIPTION OF THE DRAWINGS

FIG. 1 is a side elevation, sectional and schematic view of the entire power transmission system comprising the present invention showing the crank arms with respect to the geneva plate, sprockets and post ring;

FIG. 2 is a side elevational and fragmented view of the power transmission system fixedly secured to a bicycle frame.

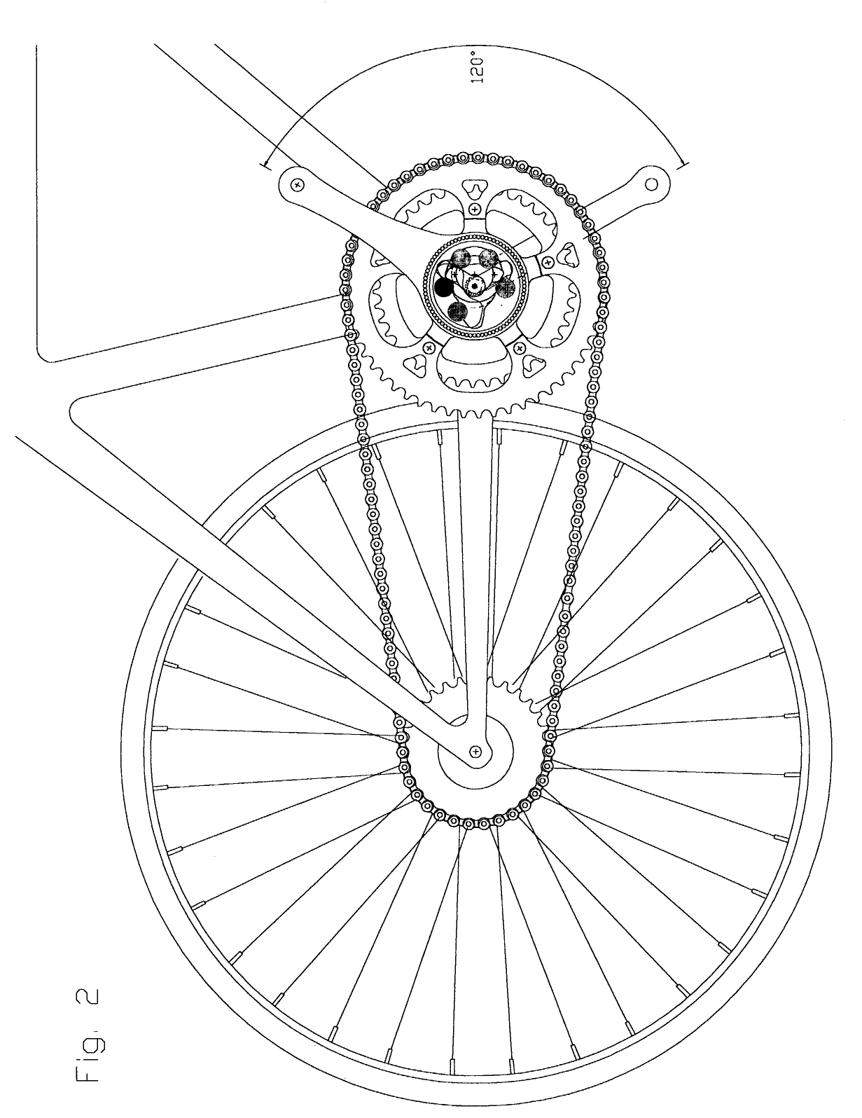

FIG. 3 is the enlarged section of the power transmission system as shown in FIG. 2 where the right crank arm is beginning its power stroke and the left crank arm is ending its power stroke.

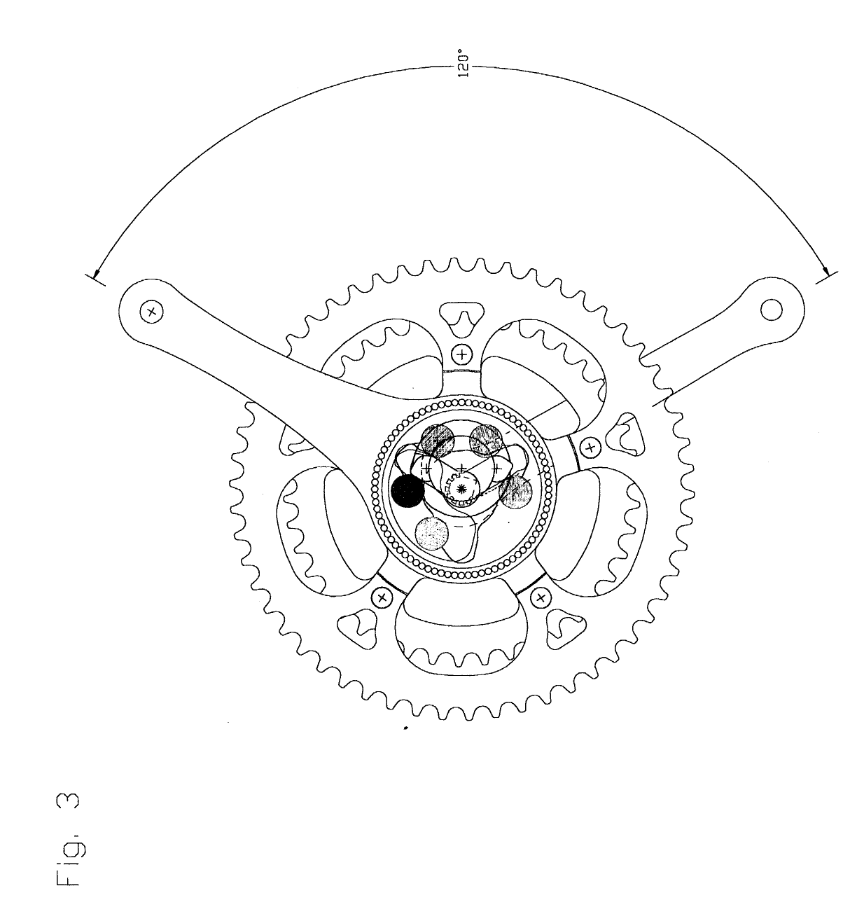

FIG. 4 is the enlarged section of the power transmission system as shown in FIG. 2 where the right crank arm is ending its power stoke and the left crank arm is beginning its power stoke.

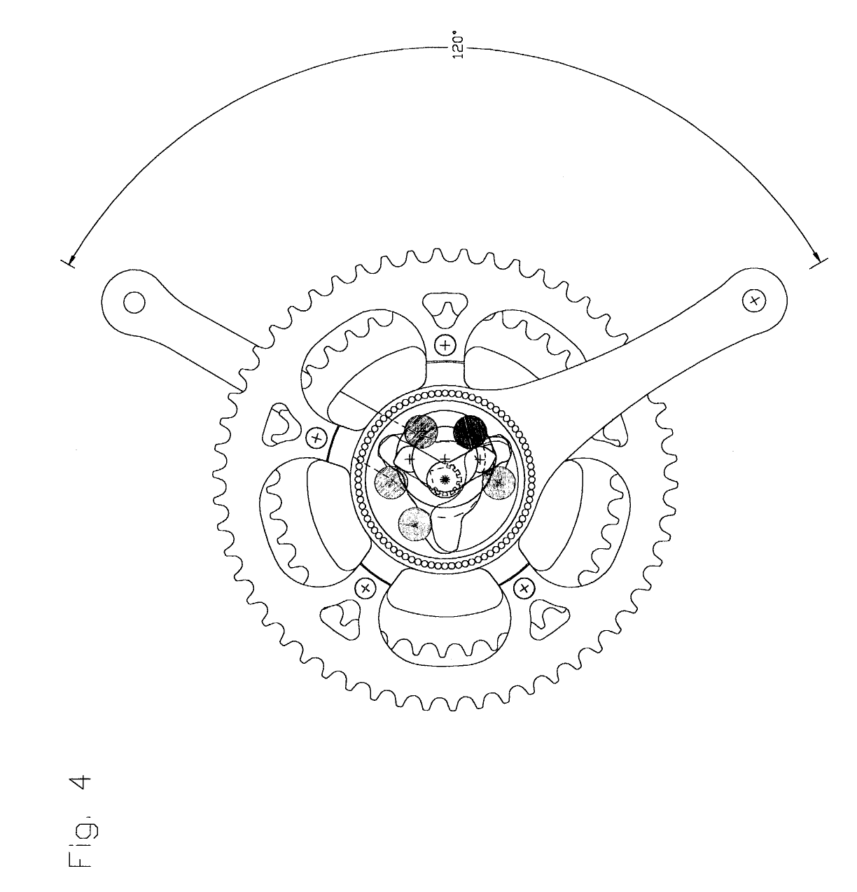

### DETAILED DESCRIPTION OF THE PREFERRED EMBODIMENT

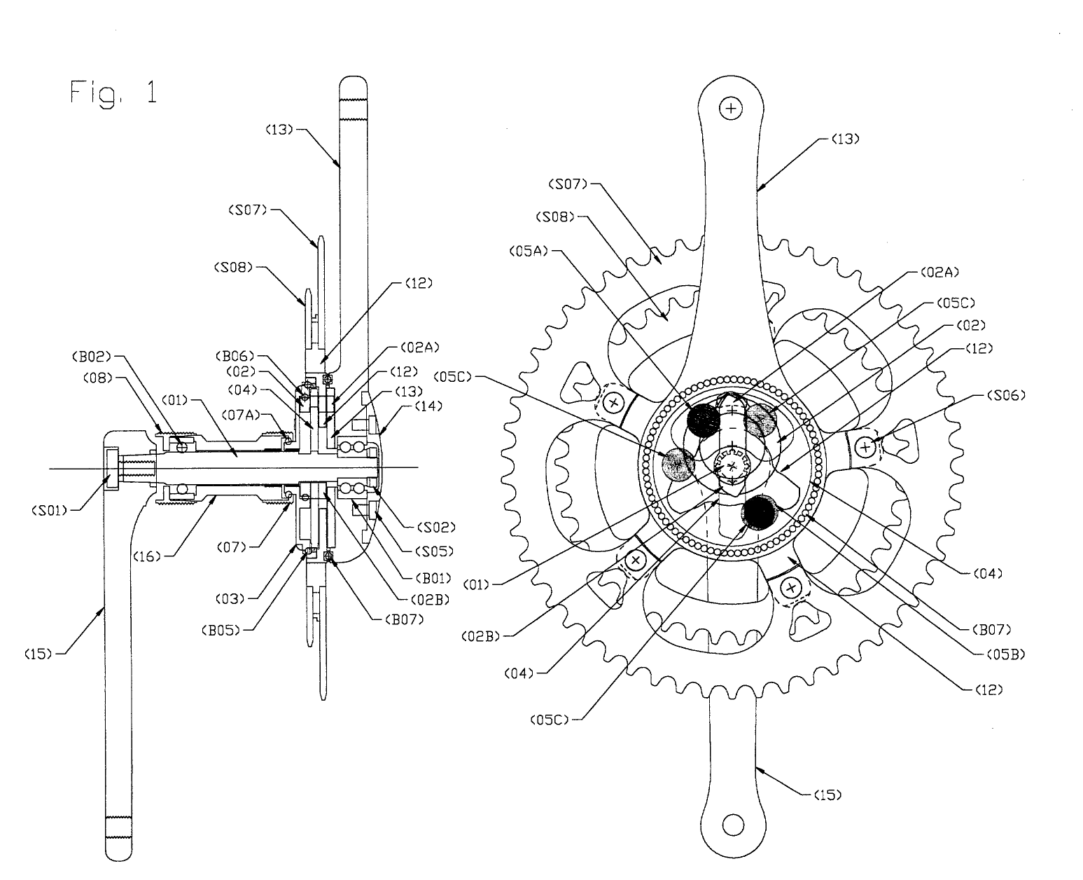

Referring now to the drawings and particularly to FIG. 1, a left crank arm 15 is fixedly secured to a spindle 01 via taper fit with bolt S01 which is fixedly secured to a left drive plate 04 via spline fit in which they all rotate concentrically with respect to the spindle 01. Spindle 01 is limited to radial and axial movement by confining it to a left frame cup 08 via a ball bearing B02. Left frame cup 08 is then press locked via a taper fit to a frame cup bridge 16 which connects the two frame cups in order to limit the axial movement of the right frame cup 07 relative to the post ring housing 03. Left drive plate 04 incorporates a left disc bearing 05B which drives a short cam post 02B; and a radial slot to limit the travel of the short cam post 02B. Short cam post 02B and long cam post 02A are fixedly secured to the post ring 02 exactly 180 degrees apart. Post ring 02 is rotatably mounted on a post ring housing 03 via ball bearing B06 in order that post ring 02 freely and eccentrically rotated within post ring housing 03. Post ring housing 03 is fixedly secured to a right frame cup 07 via a ball indexing clutch 07A where the spindle freely rotates concentrically with respect to post ring housing 03. The ball indexing clutch 07A allows for the setting angle, during installation on the bicycle frame, of the post ring housing 03 to be optimized for any variable angle. A geneva plate 12 incorporates three geneva disc bearings 05C with three radial slots which is rotatably mounted via ball bearing B05 to the post ring housing 03 and rotates concentrically with respect to spindle 01. The geneva plate 12 is the base in which the sprocket are fixedly secured via chain ring bolts S06. A right crank arm 13 is rotatably mounted to the spindle via ball bearing B01 and rotatably mounted to the genva plate via ball bearing B07 in which they all rotate concentrically with respect to the spindle 01. The right crank arm 13 is mounted in such a way that the left crank arm 15 is 180 degrees apart when the right crank arm 13 radial slot, long cam post 02A, short cam post 02B and the left crank arm 15 radial slot are all in line. The ball bearing B01 is limited in axial movement via spindle nut/washer S02. A right crank cover is mounted via screws S05 to limit the axial movement of the right crank arm 13. The right crank arm 13 incorporates a right disc bearing 05A which drives a long cam post 02A; and a radial slot to limit the travel of the long cam post 02A.

To describe the apparatus more particularly, the left crank arm 15 drives the spindle 01 that drives the left drive plate 04 that drives the left disc bearing 05B with radial slot that drives the short cam post 02B. The short cam post 02B concurrently drive the eccentrically positioned post ring 02 and only 120 degrees rotation of the geneva plate 12 via one of the three geneva disc bearings 05C. The post ring 02 drives the long post cam 02A which drives the right disc bearing 05A with radial slot that drives the right crank arm 13. The long cam post 02A concurrently drive the right crank arm 13 via right disc bearing 05A with radial slot and only 120 degrees rotation of the geneva plate via one of the three geneva disc bearings 05C. For example, the left crank arm 15 is rotated 120 degrees which in turn rotates the geneva plate 12 120 degrees which in turn rotates the right crank arm 13 240 degrees; conversely, the right crank arm 13 is rotated 120 degrees which in turn rotates the geneva plate 12 120 degrees which in turn rotates the left crank arm 15 240 degrees.

The power transmission system comprising the present invention has been illustrated and described in operable form. It is to be realized that optimum dimensional relationships for the parts of the invention to include variations in size, materials, shape, form, function and manner of operation, assembly and use are deemed readily apparent and obvious to one skilled in the art. All equivalent relationships to those illustrated in the drawings and described in the specification are intended to be encompassed herein. The foregoing is considered as illustrative only of the principles of the invention. Numerous modifications and changes will readily occur to those skilled in the art, and it is not desired to limit the invention to the exact construction and operation shown and described. All suitable modifications and equivalents that fall within the scope of the appended claims are deemed within the present inventive concept.

What is claimed is:

1. A power transmission system comprising: a vehicle power wheel with a fixed axle; a rotatable chain sprocket; transmission cadence varying means; and an endless chain connecting the wheel with the transmission cadence varying means, the transmission cadence varying means including a left crank arm fixedly secured to the spindle which is fixedly and concentrically secured to the left drive plate, a post ring eccentrically positioned with respect to the spindle incorporating a short cam post and a long cam post, a geneva plate rotatably and concentrically secured to the post ring housing and right crank arm, and a right crank arm rotatably and concentrically secured to the spindle and geneva plate, and means to rotate the left crank arms and right crank arms systematically via the engaged cam posts.

2. The system as claimed in claim 1 wherein the cam posts are fixedly secured to the eccentrically positioned post ring.

3. The system as claimed in claim 1 wherein the short cam post is 180 apart from the long cam post.

4. The system as claimed in claim 1 wherein the cam posts are engaged in radial slots in the left drive plate and the right crank arm.

5. The system as claimed in claim 1 wherein the geneva plate, left drive plate and right crank arm incorporate disc bearings so as to reduce friction in the drive.

6. The system as claimed in claim 1 wherein the right frame cup is mated with the post ring housing via an ball indexing clutch in which the ball indexing clutch allows for the setting angle, during installation on the bicycle frame, of the post ring housing to be optimized for a variable angle with respect to the bicycle frame chainstays.

7. The system as claimed in claim 1 wherein variable size sprockets can be mounted on the geneva plate.
